(19) United States
(12) Patent Application Publication
(10) Pub. No.: US 2015/0153890 A1
(43) Pub. Date: Jun. 4, 2015

(54) COMPENSATING FOR A LATENCY IN DISPLAYING A PORTION OF A HAND-INITIATED MOVEMENT

(71) Applicant: Elwha LLC, Bellevue, WA (US)

(72) Inventors: Steven Bathiche, Kirkland, WA (US); Jesse R. Cheatham, III, Seattle, WA (US); Paul H. Dietz, Redmond, WA (US); Matthew G. Dyor, Bellevue, WA (US); Philip A. Eckhoff, Kirkland, WA (US); Anoop Gupta, Woodinville, WA (US); Kenneth P. Hinckley, Redmond, WA (US); Roderick A. Hyde, Redmond, WA (US); Muriel Y. Ishikawa, Livermore, CA (US); Jordin T. Kare, Seattle, WA (US); Craig J. Mundie, Seattle, WA (US); Nathan P. Myhrvold, Medina, WA (US); Andreas G. Nowatzyk, San Jose, CA (US); Robert C. Petroski, Seattle, WA (US); Danny A. Reed, Iowa City, IA (US); Clarence T. Tegreene, Mercer Island, WA (US); Charles Whitmer, North Bend, WA (US); Lowell L. Wood, JR., Bellevue, WA (US); Victoria Y. H. Wood, Livermore, CA (US)

(21) Appl. No.: 14/095,612

(22) Filed: Dec. 3, 2013

(51) Int. Cl. G06F 3/041

(52) U.S. Cl. CPC G06F 3/0416

(57) ABSTRACT

Described embodiments include an apparatus and a method. In an apparatus, a touch tracking circuit detects a segment of a path defined by a user contact point moving across a touch sensitive display. A motion analysis circuit determines a parameter descriptive of a motion of the user contact point during its movement across the detected segment of the path (hereafter “motion parameter”). A filter predicts in response to the motion parameter a next contiguous segment of the path defined by the user-contact point moving across the touch sensitive display. A compensation circuit initiates a display by the touch sensitive display of the detected segment of the path and the predicted next segment of the path. An updating circuit initiates an update of the detected segment of the path and the predicted next contiguous segment of the path as the user contact point moves across the touch sensitive display.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

For example, and without limitation, an embodiment of the subject matter described herein includes an apparatus. The apparatus includes a touch tracking circuit configured to detect a segment of a path defined by a user contact point moving across a touch sensitive display. The apparatus includes a motion analysis circuit configured to determine a parameter descriptive of a motion of the user contact point during its movement across the detected segment of the path (hereafter “motion parameter”). The apparatus includes a predictive filter configured to predict in response to the motion parameter a next contiguous segment of the path defined by the user-contact point moving across the touch sensitive display. The apparatus includes a latency compensation circuit configured to initiate a display by the touch sensitive display of the detected segment of the path and the predicted next segment of the path. The apparatus includes an updating circuit configured to initiate an update of the detected segment of the path and the predicted next contiguous segment of the path as the user contact point moves across the touch sensitive display.

In an embodiment, the apparatus includes the touch sensitive display. In an embodiment, the apparatus includes a computing device that includes the touch sensitive display. In an embodiment, the apparatus includes a receiver circuit configured to receive a signal generated by a handheld stylus. In an embodiment, the apparatus includes a learning circuit configured to adaptively learn a motion parameter associated with a specific user based upon a history of at least two motion parameters determined in response to the path defined by a user contact point moving across the touch sensitive display. In an embodiment, the learning circuit is further configured to store in a computer readable storage media the adaptively learned motion parameter in an association with an identifier of the specific user. In an embodiment, the apparatus includes a learning circuit configured to adaptively learn a motion parameter associated with a specific software application running on the apparatus and based upon a history of at least two motion parameters determined in response to a path defined by the user contact point moving across the touch sensitive display. In an embodiment, the learning circuit is further configured to store in a computer readable storage media the learned motion parameter in an association with an identification of the specific software application running on the apparatus. In an embodiment, the apparatus includes a non-transitory computer readable storage media.

For example, and without limitation, an embodiment of the subject matter described herein includes a method implemented in a computing environment. The method includes detecting a segment of a path defined by a user contact point moving across a touch sensitive display. The method includes determining a parameter descriptive of a motion of the user contact point during its movement across the detected segment of the path (hereafter “motion parameter”). The method includes predicting in response to the motion parameter a next contiguous segment of the path of the user contact point moving across the touch sensitive display. The method includes displaying a human-perceivable rendering of the detected segment of the path and the predicted next segment of the path. The method includes updating the detected segment of the path and the predicted next contiguous segment of the path as the user contact point moves across the touch sensitive display.

For example, and without limitation, an embodiment of the subject matter described herein includes a method implemented in a computing environment. The method includes detecting a first segment of a path defined by a user contact point moving across a touch sensitive display of the computing device. The method includes determining a first parameter descriptive of a first motion of the user contact point during its movement across the detected first segment of the path (hereafter “first motion parameter”). The method includes predicting in response to the first motion parameter a second contiguous segment of the path of the user contact point moving across the touch sensitive display. The method includes displaying on the touch sensitive display the detected first segment of the path and the predicted second segment of the path. The method includes detecting a second segment of the path defined by the user contact point moving across the touch sensitive display of the computing device. The method includes determining a second parameter descriptive of a second motion of the user contact point during its movement across the detected second segment of the path (hereafter “second motion parameter”). The method includes predicting in response to the second motion parameter a third contiguous segment of the path defined by the user contact point moving across the touch sensitive display. The method includes displaying on the touch sensitive display the detected first segment, the detected second segment, and the predicted third segment of the path.

For example, and without limitation, an embodiment of the subject matter described herein includes a method implemented in a computing environment. The method includes detecting a segment of a path defined by a user contact point moving across a touch sensitive display. The method includes determining a parameter descriptive of a motion of the user contact point during its movement across the detected segment of the path (hereafter “motion parameter”). The method includes selecting responsive to the motion parameter a time-interval forecasted to improve a correspondence between a predicted next contiguous segment of the path defined by the user contact point and a subsequently detected next contiguous segment of the path. The method includes predicting in response to the motion parameter and the selected time-interval a next contiguous segment of the path defined by the user contact point. The method includes initiating a display by the touch sensitive display of the detected segment of the path and the predicted next segment of the path. The method includes initiating an update of the detected segment of the path, and the predicted next contiguous segment of the path as the user contact point moves across the touch sensitive display.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of an environment 19 that includes a thin computing device 20 in which embodiments may be implemented;

FIG. 2 illustrates an example embodiment of an environment 100 that includes a general-purpose computing system 110 in which embodiments may be implemented;

FIG. 3 schematically illustrates an example environment 200 in which embodiments may be implemented;

FIGS. 4A-4C illustrate examples of the detected and predicted segments of a path defined by a user contact point moving across a touch sensitive display of an apparatus 205;

FIG. 5 illustrates an example operational flow 300 implemented in a computing device;

FIG. 6 illustrates an example operational flow 400 implemented in a computing device;

FIG. 7 schematically illustrates an example environment 500 in which embodiments may be implemented;

FIG. 8 illustrates an example operational flow 600 implemented in a computing device;

FIG. 9 illustrates an example apparatus 700;

FIG. 10 schematically illustrates an example environment 800 in which embodiments may be implemented;

FIG. 11 illustrates an example operational flow 900 implemented in a computing device;

FIG. 12 schematically illustrates an example environment 1000 in which embodiments may be implemented; and

FIG. 13 illustrates an example operational flow 1100 implemented in a computing device.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

This application makes reference to technologies described more fully in U.S. patent application Ser. No. ______, filed Dec. 3, 2013, entitled IMPROVED LATENCY COMPENSATION IN A DISPLAY OF A PORTION OF A HAND-INITIATED MOVEMENT, and Ser. No. ______, filed Dec. 3, 2013, entitled DISPLAY LATENCY COMPENSATION RESPONSIVE TO AN INDICATOR OF AN IMPENDING CHANGE IN A HAND-INITIATED MOVEMENT. Both of these applications are incorporated by reference herein, including any subject matter included by reference in those applications.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch-sensitive screen or display surface, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch-sensitive screen or display surface, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

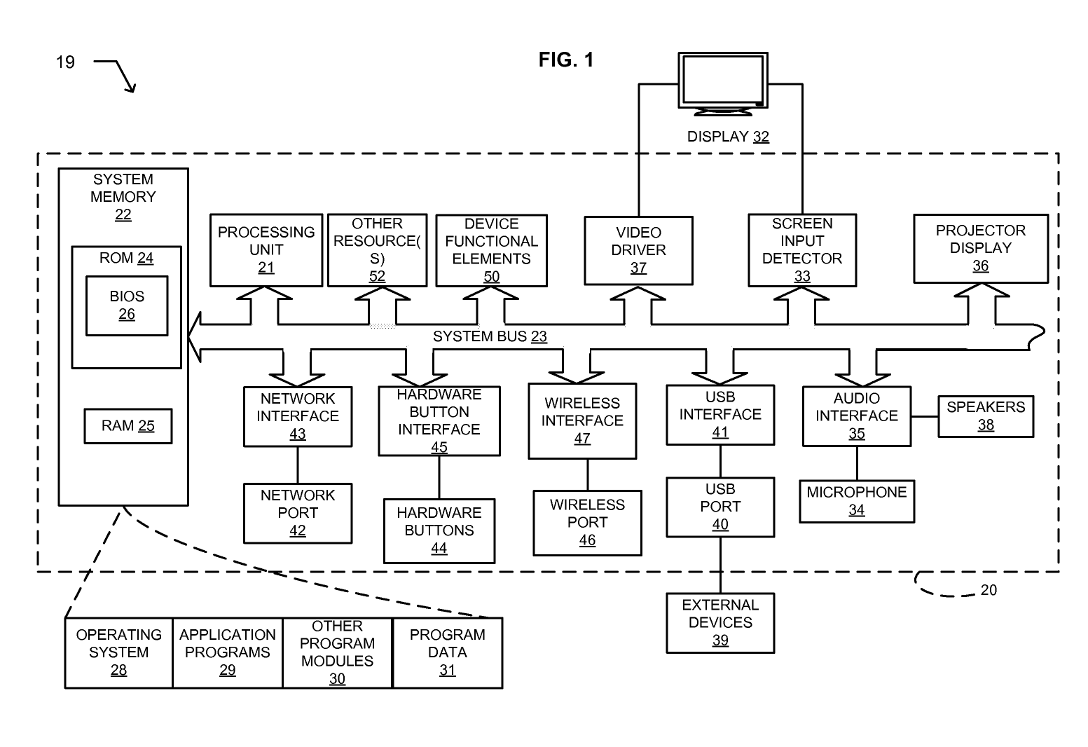

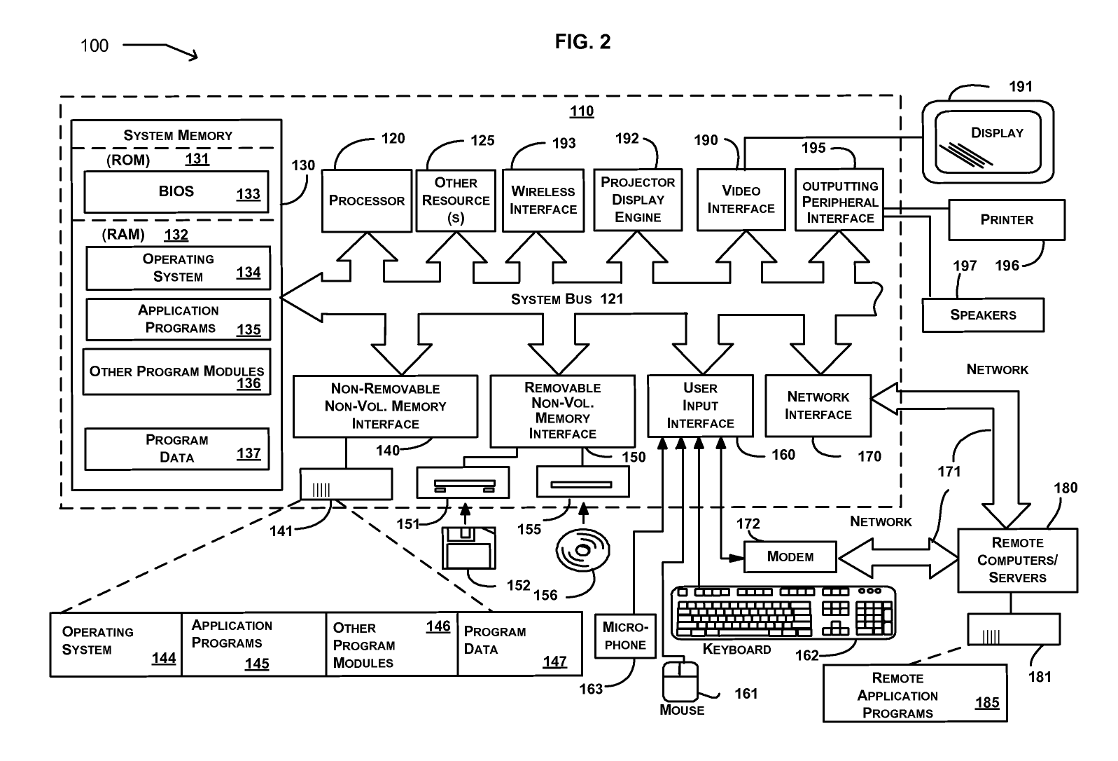

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media. By way of further example, and not of limitation, computer-readable media may include a communication media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media may include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” ® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing a communication link between the computers may be used.

In certain instances, one or more elements of the computing device 110 may be deemed not necessary and omitted. In other instances, one or more other elements may be deemed necessary and added to the computing device.

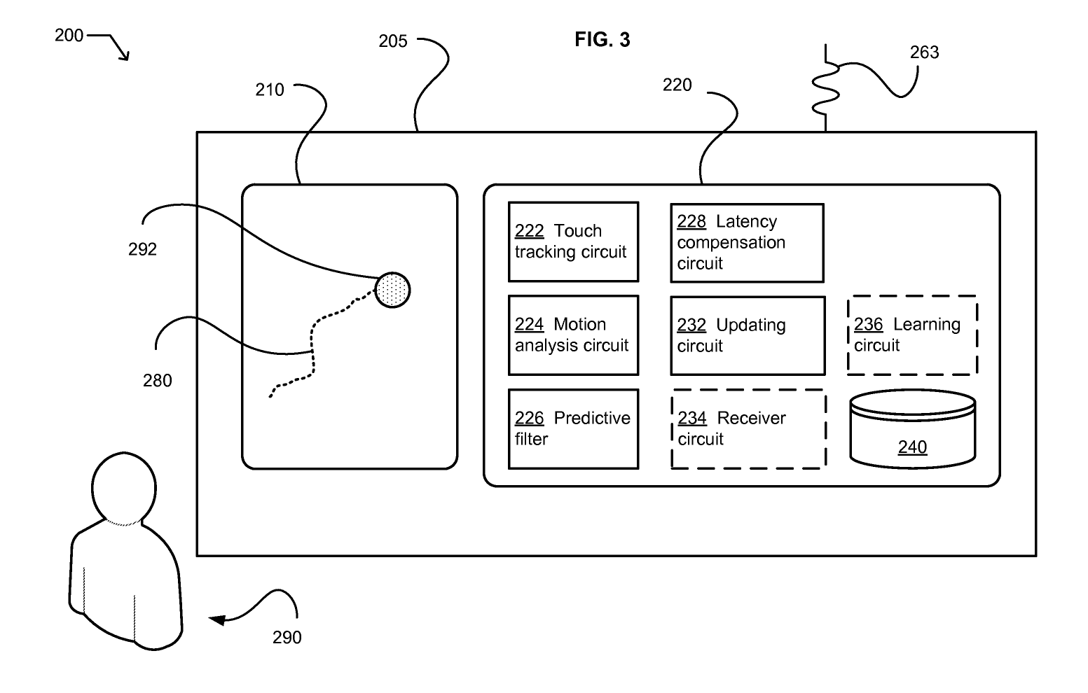

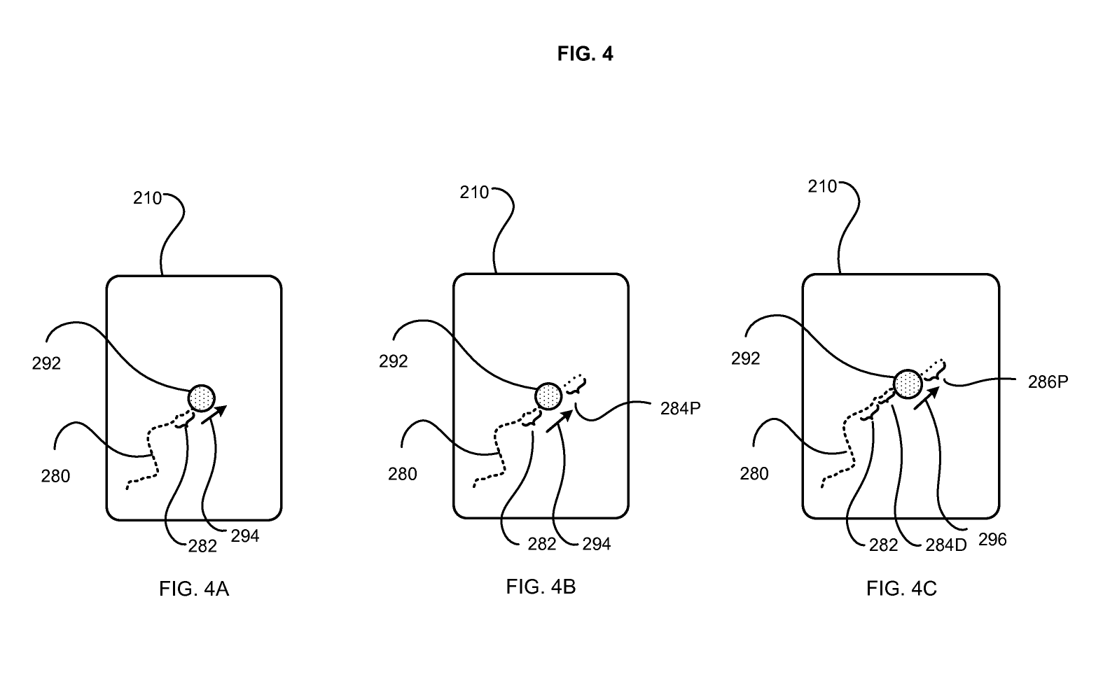

FIG. 3 schematically illustrates an example environment 200 in which embodiments may be implemented. The environment includes a device 205, illustrated as a computing device, and a user 290. In an embodiment, the device may include the thin computing device 20 illustrated in the computing environment 19 described in conjunction with FIG. 1. In an embodiment, the device may include the general purpose computing device 110 described in conjunction with the general purpose computing environment 100. The device includes a touch sensitive display 210. The environment includes an apparatus 220, which includes a touch tracking circuit 222 configured to detect a segment of a path 280 defined by a user contact point 292 moving across the touch sensitive display. For example, in an embodiment, the path may be defined by the user contact point moving across a relatively small portion of the touch sensitive display, such when forming a letter or a word, such as when forming an element of a graphic, such as when forming a swipe. FIG. 4A illustrates an embodiment that includes a segment 282 of the path 280 defined by the user contact point moving across the touch sensitive display. The apparatus includes a motion analysis circuit 224 configured to determine a parameter descriptive of a motion of the user contact point during its movement across the detected segment of the path (hereafter “motion parameter”). FIG. 4A illustrates the motion of the user contact point by a motion 294. The apparatus includes a predictive filter 226 configured to predict in response to the motion parameter a next contiguous segment of the path defined by the user-contact point moving across the touch sensitive display. FIG. 4B illustrates the predicted next contiguous segment 284P of the path. In a latency compensation situation, a touch screen tracking system often lags behind the actual user-contact point because of latency inherent in the tracking system. In an embodiment, the predicted next contiguous segment is predicting where the user contact point has actually moved but of which detection has not been achieved because of the latency inherent in the touch screen tracking system. The apparatus includes a latency compensation circuit 228 configured to initiate a display by the touch sensitive display of the detected segment of the path and the predicted next segment of the path. The apparatus includes an updating circuit 232 configured to initiate an update of the detected segment of the path and the predicted next contiguous segment of the path as the user contact point moves across the touch sensitive display. As the updating of the detected segment of the path and the predicted next contiguous segment of the path occurs, the latency compensation circuit updates the detected and predicted segments displayed by the touch sensitive display. For example, FIG. 4C illustrates an example of the updating. In response to the updating, the touch sensitive display presents a detected second segment 284D of the path and a second predicted segment 286P of the path. In response to the updating, a second parameter of the motion of the user contact point is determined, which is illustrated by a motion 296. In an embodiment, the updating circuit is configured to initiate a dynamic updating of the detected segment of the path and the predicted next contiguous segment of the path as the user contact point moves across the touch sensitive display.

In an embodiment, the user contact point 292 includes a tip of a finger of the user. In an embodiment, the user contact point includes a tip of a handheld stylus held by the user. In an embodiment, the path 280 is defined by the user contact point moving across and touching the touch sensitive display 210.

In an embodiment, the motion analysis circuit 224 is further configured to analyze an aspect of the movement of the user contact point 292 across the detected segment 282 of the path 280, and to determine a parameter descriptive of a motion 294 of the user contact point during its movement across a detected segment of the path based on the analyzed aspect. In an embodiment, the motion parameter is descriptive of an aspect of the motion of the user contact point. In an embodiment, the motion parameter is descriptive of the motion of the user contact point during a portion of its movement across the detected segment of the path. In an embodiment, the motion parameter includes a velocity parameter of the user contact point. For example, a velocity parameter may include a parameter responsive to a linear or rotation motion of the user contact point. For example, a velocity parameter may involve a projection of 3D motion onto the plane of the touchscreen. For example, a change in motion may be due to changes in direction. For example, a motion parameter may indicate angular velocity, angular acceleration, or the like. For example, a motion parameter may be based upon a time history of the contact point. For example, a motion parameter may be inferred in response to a proximity of the user contact point to an outer perimeter of the touch sensitive display. For example, a motion parameter may be based upon data received from the touchscreen's digitizer. In an embodiment, the motion parameter includes a two-dimensional velocity parameter of the user contact point. In an embodiment, the motion parameter includes an acceleration parameter of the user contact point. For example, an acceleration, jerk, or higher derivatives. An acceleration parameter may indicate a change in speed, either speeding up or slowing down. In an embodiment, the motion parameter includes a two-dimensional acceleration parameter of the user contact point. In an embodiment, the motion parameter includes an orientation or motion of the user contact point relative to the touch sensitive display. For example, the motion may include a linear or an angular motion. In an embodiment, the motion parameter includes a difference between a detected motion and a previously made prediction of the motion. In an embodiment, the motion parameter includes a curvature of the path. In an embodiment, the motion parameter includes (i) a motion parameter of the user contact point and (ii) a motion parameter of a finger or a hand of the user forming the contact point, or of a handheld stylus forming the contact point.

In an embodiment, the motion analysis circuit 224 is further configured to determine a parameter descriptive of a motion of the user contact point 292 defined by a tip of a handheld stylus during its movement across the detected segment 282 of the path 280. In an embodiment, the determination is responsive to a signal generated by the handheld stylus and indicative of a sensed parameter descriptive of a motion of the handheld stylus during its movement across detected segment of the path. In an embodiment, the signal includes data indicative of a velocity or acceleration of the handheld stylus. For example, the data may include data acquired using accelerometers carried by the handheld stylus having a known distance from the tip. For example, the data may include data indicative of a stylus orientation, stylus angular motion, or the like. In an embodiment, the sensed parameter includes a sensed parameter indicative of a two-dimensional velocity of the tip of the handheld stylus. In an embodiment, the sensed parameter may be indicated by a vector. In an embodiment, the sensed parameter includes a linear or angular motion of the tip of the handheld stylus. In an embodiment, the sensed parameter includes a projection of 3D motion onto the plane of the touchscreen. In an embodiment, the sensed parameter includes a sensed parameter indicative of a two-dimensional acceleration of the tip of the handheld stylus. In an embodiment, the sensed parameter includes a sensed parameter indicative of an orientation or [linear, angular] motion of the handheld stylus relative to the touch sensitive display. For example, the motion may include a linear or an angular motion. In an embodiment, the sensed parameter includes a sensed parameter indicative of a motion of the tip of the handheld stylus and a sensed parameter of a motion of another portion of the handheld stylus.

In an embodiment, the motion analysis circuit 224 is further configured to determine a parameter descriptive of a motion of the tip of the handheld stylus during its movement across the detected segment of the path. The determination is responsive to (i) a signal generated by the handheld stylus and indicative of a sensed parameter descriptive of a motion of the tip of the handheld stylus during its movement across detected segment of the path, and (ii) an aspect of the movement of the tip of the handheld stylus across the detected segment of the path.

In an embodiment, the predictive filter 226 is configured to predict in response to the detected motion parameter a next contiguous segment 282 of the path 280 of the user contact point 292 likely to occur during a time interval. In an embodiment, the time interval is a function of the latency period of the apparatus. For example, the latency period of the apparatus may be considered as a touchscreen lag of the apparatus, sometimes referred to as touch screen latency or delay. For example, the latency period of the apparatus may include a delay imposed by the whole computing device. For example, the latency period may include a delay in displayed content between a user touch and the touch being displayed. In an embodiment, the time interval is specified by a manufacturer of a computing device into which the touch sensitive display is incorporated or by a human user. In an embodiment, the predictive filter is further configured to determine the time interval based upon an analysis of the motion parameter. In an embodiment, the predictive filter is further configured to determine the time interval based at least partially upon a weighted error rate. For example, a weighted error rate can be based upon past prediction errors. For example, errors can be weighted with respect to time, so that preference is given to longer predictions. In an embodiment, the predictive filter is further configured to determine an optimum update schedule usable by the updating circuit 232 in response to a historical iterative convergence between the predicted likely next segment and the actual detected next segment. For example, an update schedule may be considered a refresh rate. For example, the update schedule may be subject to limitations otherwise inherent in the device 205. In an embodiment, the predictive filter is further configured to dynamically determine an optimized update schedule usable by the updating circuit. In an embodiment, the predictive filter is configured to predict in response to the motion parameter of the user contact point and in response to a motion parameter of the touch sensitive display a next contiguous segment of the path of the user contact point moving across the touch sensitive display. For example, the prediction may involve projection of 3D motion onto the plane of the touchscreen. For example, the prediction may involve subtraction of touchscreen acceleration. In an embodiment, the predictive filter includes a Kalman filter. In an embodiment, the predictive filter includes a model-based filter. For example, the motion prediction may combine a motion parameter extension with course-prediction (e.g., prediction of the letter, symbol, word, screen destination). In an embodiment, the predictive filter includes a high-speed digitizer configured to obtain sufficient sample points for the predictive filter to predict in response to the motion parameter a next contiguous segment of the path defined by the user-contact point moving across the touch sensitive display.

In an embodiment, the updating circuit 232 is configured to initiate an update of the detected segment of the path and the predicted next contiguous segment of the path as the user contact point 292 moves across the touch sensitive display 210 based on a schedule. In an embodiment, the schedule includes an optimization schedule determined by the predictive filter. In an embodiment, the schedule includes initiating an update at least once during a latency period of the apparatus. In an embodiment, the updating circuit is configured to initiate an update of the detected segment of the path 282 and the predicted next contiguous segment 284P of the path 280 as the user contact point moves across the touch sensitive display based on a length of the detected segment of the path. In an embodiment, the updating circuit is further configured to initiate updates while a handheld stylus moves across the touch sensitive display. In an embodiment, the updating circuit is configured to initiate a display by the touch sensitive display of the detected segment of the path and the predicted next segment of the path concurrent with the movement across the touch sensitive display by the user contact point. In an embodiment, the updating circuit is configured to initiate a display by the touch sensitive display of the detected segment of the path using a first visual representation and of the predicted next segment of the path using a second visual representation that is humanly distinguishable from the first visual representation. For example, a first visual representation of the detected segment may include a solid black line, and a second visual representation of the predicted next segment may include a dashed black line. For example, a first visual representation of the detected segment may include a black line, and a second visual representation of the predicted next segment may include a red line. As the display is updated in response to the updating circuit, the first visual representation and second visual representations are continually updated as the user contact point moves across the touch sensitive display.

In an embodiment, the apparatus 220 further comprises the touch sensitive display 210. In an embodiment, the apparatus includes the device 205 that includes the touch sensitive display 210. In an embodiment, the apparatus includes a receiver circuit 234 configured to receive a signal generated by a handheld stylus. In an embodiment, the receiver circuit may include a wireless receiver circuit 263. In an embodiment, the apparatus includes a learning circuit 236 configured to adaptively learn a motion parameter associated with a specific user based upon a history of at least two motion parameters determined in response to the path defined by a user contact point moving across the touch sensitive display. In an embodiment, the learning circuit is further configured to store in a computer readable storage media 240 the adaptively learned motion parameter in an association with an identifier of the specific user. In an embodiment, the learning circuit is configured to adaptively learn a motion parameter associated with a specific software application running on the apparatus and based upon a history of at least two motion parameters determined in response to a path defined by the user contact point moving across the touch sensitive display. In an embodiment, the learning circuit is further configured to store in a computer readable storage media the learned motion parameter in an association with an identification of the specific software application running on the apparatus. In an embodiment, the apparatus includes a non-transitory computer readable storage media.

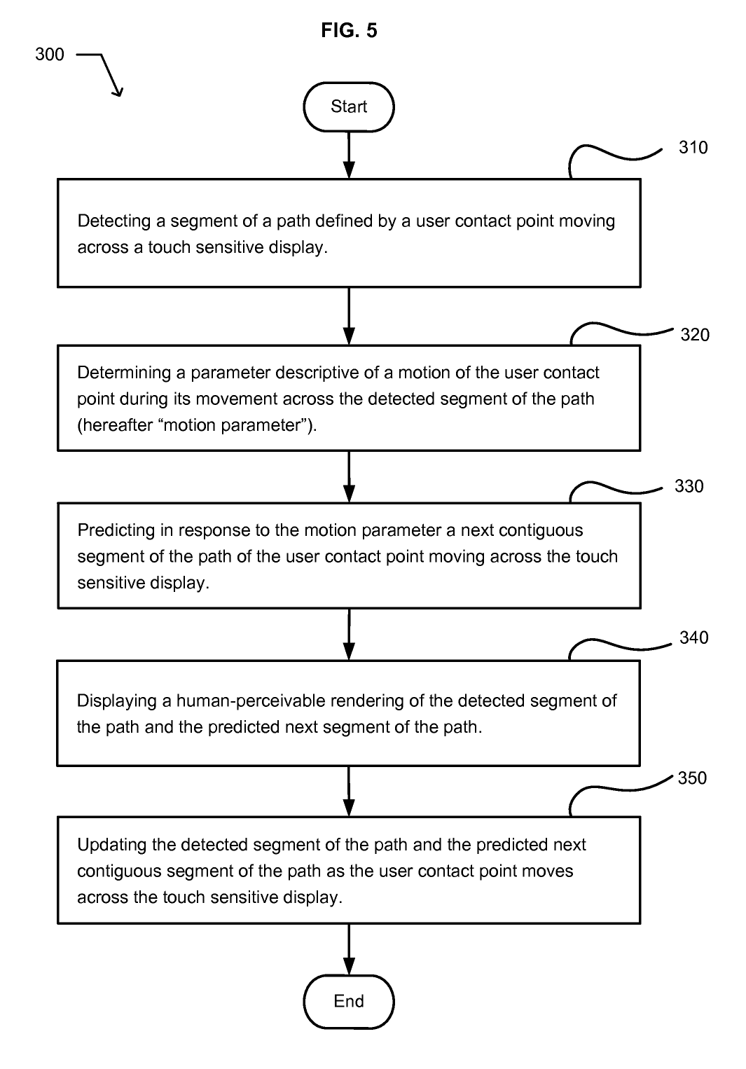

FIG. 5 illustrates an example operational flow 300 implemented in a computing device. In an embodiment, the computing device may include the thin computing device 20 illustrated in the computing environment 19 described in conjunction with FIG. 1. In an embodiment, the device may include the general purpose computing device 110 described in conjunction with the general purpose computing environment 100 described in conjunction with FIG. 2. After a start operation, the operational flow includes a tracking operation 310. The tracking operation includes detecting a segment of a path defined by a user contact point moving across a touch sensitive display. In an embodiment, the tracking operation may be implemented using the touch tracking circuit 222 described in conjunction with FIG. 3. An analysis operation 320 includes determining a parameter descriptive of a motion of the user contact point during its movement across the detected segment of the path (hereafter “motion parameter”). In an embodiment, the analysis operation may be implemented using the motion analysis circuit 224 described in conjunction with FIG. 3. A prediction operation 330 includes predicting in response to the motion parameter a next contiguous segment of the path of the user contact point moving across the touch sensitive display. In an embodiment, the prediction operation may be implemented using the predictive filter 226 described in conjunction with FIG. 3. A display operation 340 includes displaying a human-perceivable rendering of the detected segment of the path and the predicted next segment of the path. The display operation may be initiated by the latency compensation circuit 228 initiating the displaying by the touch sensitive display 210 as described in conjunction with FIG. 3. An update operation 350 includes updating the detected segment of the path and the predicted next contiguous segment of the path as the user contact point moves across the touch sensitive display. In an embodiment, the updating may include a continuously updating the detected segment of the path and the predicted next contiguous segment of the path. In an embodiment, the updating may include an incrementally updating the detected segment of the path and the predicted next contiguous segment of the path. In an embodiment, the updating may include a repeatedly updating the detected segment of the path and the predicted next contiguous segment of the path. In an embodiment, the update operation may be implemented using the updating circuit 232 described in conjunction with FIG. 3. The operational flow includes an end operation.

In an embodiment, the analysis operation 330 includes analyzing an aspect of the movement of the user contact point across the detected segment of the path, and determining a parameter descriptive of a motion of the user contact point during its movement across the detected segment of the path based on the analyzed aspect. In an embodiment, the analysis operation includes determining a parameter descriptive of a motion of the user contact point during its movement across the detected segment of the path based on a signal generated by the handheld stylus and indicative of a sensed parameter descriptive of a motion of the user contact point during its movement across the detected segment of the path.

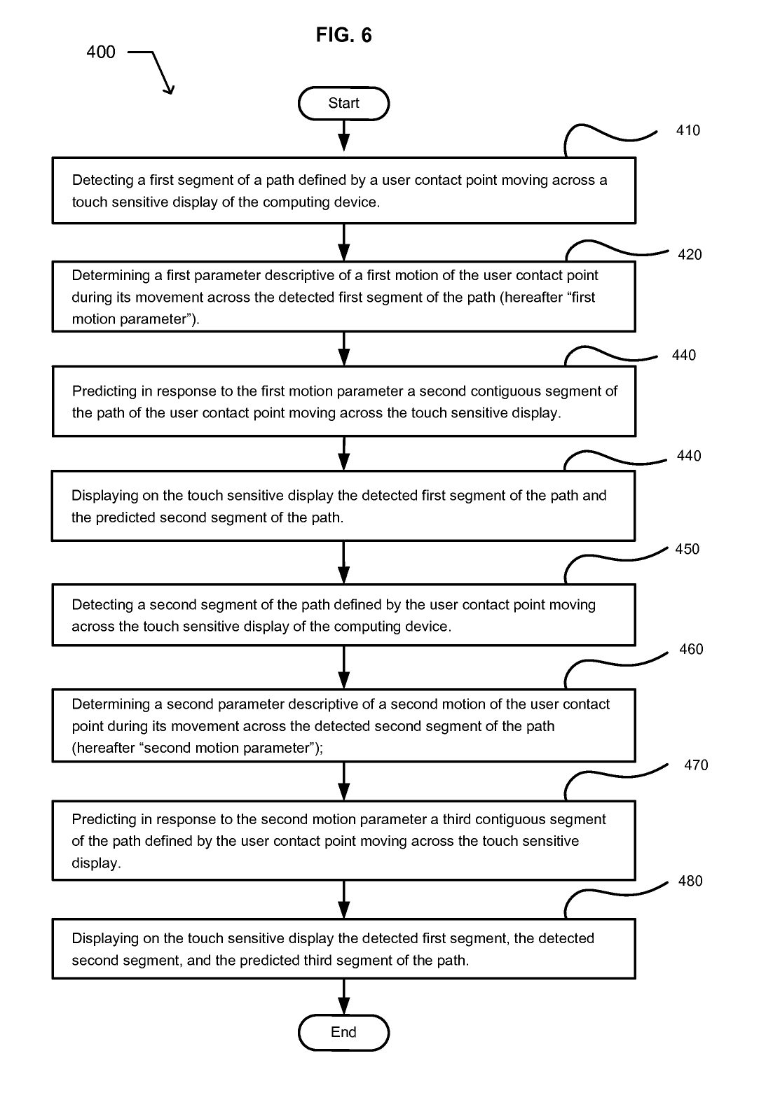

FIG. 6 illustrates an example operational flow 400 implemented in a computing device. In an embodiment, the computing device may include the thin computing device 20 illustrated in the computing environment 19 described in conjunction with FIG. 1. In an embodiment, the device may include the general purpose computing device 110 described in conjunction with the general purpose computing environment 100 described in conjunction with FIG. 2. After a start operation, the operational flow includes a first tracking operation 410. The first tracking operation includes detecting a first segment of a path defined by a user contact point moving across a touch sensitive display of the computing device. A first analysis operation 420 includes determining a first parameter descriptive of a first motion of the user contact point during its movement across the detected first segment of the path (hereafter “first motion parameter”). A first prediction operation 430 includes predicting in response to the first motion parameter a second contiguous segment of the path of the user contact point moving across the touch sensitive display. A first display operation 440 includes displaying on the touch sensitive display the detected first segment of the path and the predicted second segment of the path. A second tracking operation 450 includes detecting a second segment of the path defined by the user contact point moving across the touch sensitive display of the computing device. In an embodiment, the first and second tracking operations may be implemented using the touch tracking circuit 222 described in conjunction with FIG. 3. A second analysis operation 460 includes determining a second parameter descriptive of a second motion of the user contact point during its movement across detected second segment of the path (hereafter “second motion parameter”). In an embodiment, the first and second analysis operations may be implemented using the motion analysis circuit 224 described in conjunction with FIG. 3. A second prediction operation 470 includes predicting in response to the second motion parameter a third contiguous segment of the path defined by user contact point moving across the touch sensitive display. In an embodiment, the first and second prediction operations may be implemented using the predictive filter 226 described in conjunction with FIG. 3. A second display operation 480 includes displaying on the touch sensitive display the detected first segment, the detected second segment, and the predicted third segment of the path. In an embodiment, the first and second display operations may be implemented using the touch tracking circuit 222 described in conjunction with FIG. 3. The display operation may be initiated by the latency compensation circuit 228 initiating the displaying by the touch sensitive display 210 as described in conjunction with FIG. 3. The operational flow includes an end operation.

In an embodiment, the first detection operation 410 includes detecting a first segment of a continuing path of the user contact point moving across the touch sensitive display. In an embodiment, the first prediction operation 430 includes analyzing an aspect of the movement of the user contact point across the detected first segment of the path, and determining a first parameter descriptive of a motion of the user contact point during its movement across detected first segment of the path based on the analyzed aspect.

In an embodiment, the first prediction operation 430 includes determining a first parameter descriptive of a motion of a tip of a stylus held by the user during its movement across the detected first segment of the path based on a first signal generated by the handheld stylus and indicative of a parameter descriptive of a sensed motion of the tip of the handheld stylus during its movement across detected first segment of the path. In an embodiment, the first signal is indicative of a parameter descriptive of a sensed motion of the tip of the handheld stylus relative to the touch sensitive display device during its movement across a portion of the detected first segment of the path. In an embodiment, the operational flow 400 may include receiving the first signal generated by the handheld stylus and indicative of a sensed motion parameter of the user contact point during a portion of the detected first segment of the path. In an embodiment, the first prediction operation includes detecting a first segment of a continuing path of the user contact point moving across the touch sensitive display. In an embodiment, the first determining operation includes determining a parameter descriptive of a motion of the user contact point during a portion of the movement of the user contact point across the detected first segment of the path. For example, the portion of movement may include movement over a portion of the detected first segment, such as middle 50%, last 25%, or last 10%. In an embodiment, the portion of the movement is a movement during a time interval equal to or less than a detection latency period of the touch sensitive display. In an embodiment, the portion of the movement is a movement during a time interval less than one-half of the detection latency period of the touch sensitive display. In an embodiment, the portion of the movement is less than one-half of the linear length of the detected first segment of the path. In an embodiment, the first segment and the second segment are contiguous portions of the path of the user contact point. In an embodiment, the predicted second segment has a time interval at least equal to a detection latency period of the touch sensitive display. In an embodiment, the predicted second segment has a time interval specified by a manufacturer of the computing device or by a human user of the computing device. In an embodiment, the predicted second segment has an optimized time interval selected in response to an analysis of the movement of the handheld stylus across the touch sensitive display. In an embodiment, the predicted second segment has a length approximately equal to a length of the first segment. In an embodiment, the predicted second segment includes a segment of the path of the user contact point moving across the touch sensitive display formed subsequent to the formation of the first segment and not yet detected. In an embodiment, the predicted second segment includes a predicted second segment responsive to a forward projection of the first sensed motion parameter. For example, the forward projection of the first sensed motion parameter may be a speed, acceleration, direction change parameter. In an embodiment, the predicted second segment includes a predicted second segment responsive to an extension of the sensed motion parameter combined with a course-prediction. For example, a course prediction may include a prediction of a possible letter, symbol, word, or screen destination. For example, a course prediction may be responsive to one or more detected segments of the path defined by the user contact point.

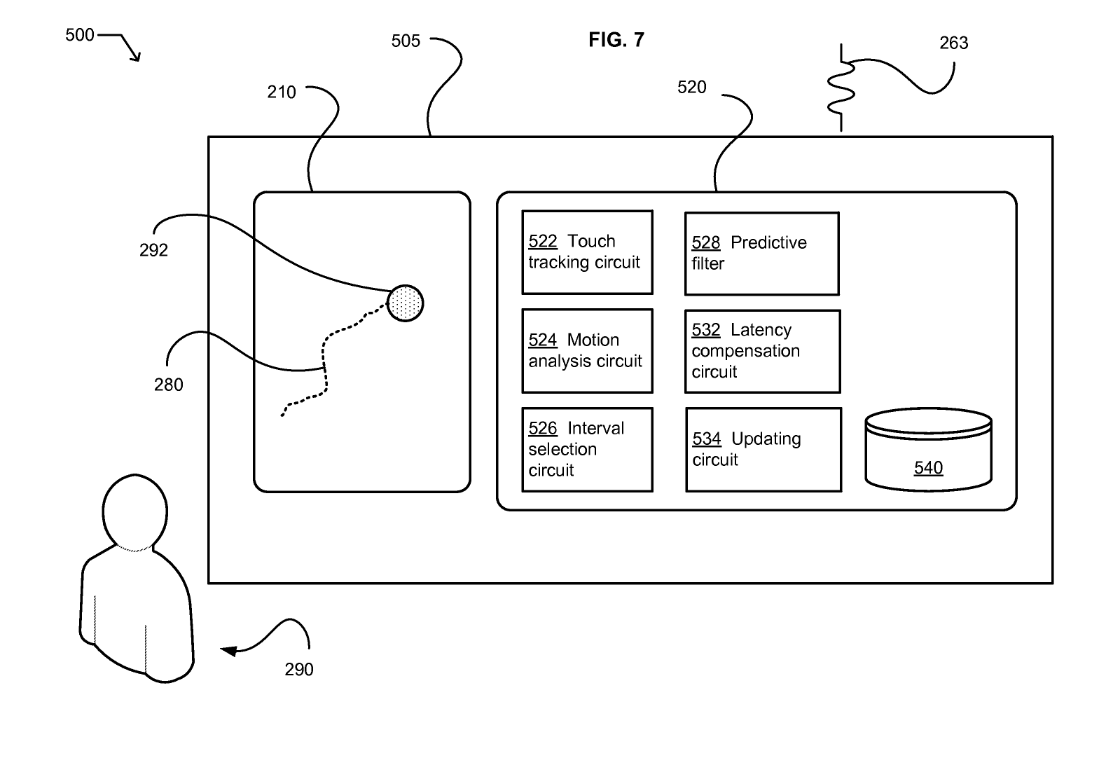

FIG. 7 schematically illustrates an example environment 500 in which embodiments may be implemented. The environment includes a device 505, illustrated as a computing device, and the user 290. In an embodiment, the device may include the thin computing device 20 illustrated in the computing environment 19 described in conjunction with FIG. 1. In an embodiment, the device may include the general purpose computing device 110 described in conjunction with the general purpose computing environment 100. The device includes the touch sensitive display 210 and an apparatus 520.

The apparatus 520 includes a touch tracking circuit 522 configured to detect a segment 282 of the path 280 defined by a user contact point 292 moving across the touch sensitive display 210. FIG. 4 illustrates previously described features and associated reference numbers of the path. A motion analysis circuit 524 is configured to determine a parameter descriptive of a motion 294 of the user contact point during its movement across the detected segment of the path (hereafter “motion parameter”). An interval selection circuit 526 is configured to select responsive to the motion parameter a time-interval forecasted to improve a correspondence between a predicted next contiguous segment of the path defined by the user contact point and a subsequently detected 284D next contiguous segment of the path. For example, the time-interval may be selected to improve accuracy in predicting the next contiguous segment with respect to the display lag. A predictive filter 528 is configured to predict in response to the motion parameter and the selected time-interval the next contiguous segment 284P of the path defined by the user contact point. A latency compensation circuit 532 is configured to initiate a display by the touch sensitive display 210 of the detected segment of the path and the predicted next contiguous segment of the path. An updating circuit 534 is configured to initiate an update of the detected segment of the path and the predicted next contiguous segment of the path as the user contact point moves across the touch sensitive display.

In an embodiment, the interval selection circuit 526 is configured to select an increased time-interval in response to a motion parameter indicative of a hesitating motion or pausing motion of the user contact point. In an embodiment, the interval selection circuit is configured to select a decreased time-interval in response to a motion parameter indicative of an increasing speed of the user contact point across the touch sensitive display or forward jerking motion of the user contact point. In an embodiment, the interval selection circuit is configured to update the time-interval in response to a change in an aspect of the motion parameter. In an embodiment, the interval selection circuit is configured to update the time-interval in response to each instance of an updating of the detected segment of the path. In an embodiment, the interval selection circuit configured to select the time-interval responsive to the motion parameter and to available computing resources. In an embodiment, the interval selection circuit configured to select the time-interval responsive to the motion parameter, available computing resources, and an aspect of a user experience related to the touch screen display.

In an embodiment, the interval selection circuit is configured to update the time-interval based on a time schedule. For example, a schedule may be every 2 seconds, 5 seconds, or 10 seconds. In an embodiment, the interval selection circuit is configured to update the time-interval based on a schedule responsive to a specified number of instances of updating the detected segment of the path. For example, the time-interval may be each 10th update of the detected segment, or each 25th update of the detected segment. In an embodiment, the interval selection circuit is configured to update the time-interval in response a change of a user of the apparatus. In an embodiment, the interval selection circuit is configured to update the time-interval in response to a start of a new session on the apparatus by a user. In an embodiment, the interval selection circuit is configured to update the time-interval in response to a particular elapsed usage time of the touch sensitive display. For example, an elapsed time may be 1 minute, 2 minutes, or 5 minutes. In an embodiment, the interval selection circuit is configured to retrieve a stored time-interval associated with a particular user of the apparatus. For example, stored-time interval may be retrieved from a computer readable storage media 540. In an embodiment, the interval selection circuit is configured to retrieve a stored time-interval associated with a handheld stylus currently being used to form the contact point. In an embodiment, the interval selection circuit is configured to retrieve a time-interval stored in the handheld stylus. In an embodiment, the updating circuit includes an updating circuit configured to initiate an update of the selected time-interval, the detected segment of the path, and the predicted next contiguous segment of the path as the user contact point moves across the touch sensitive display.

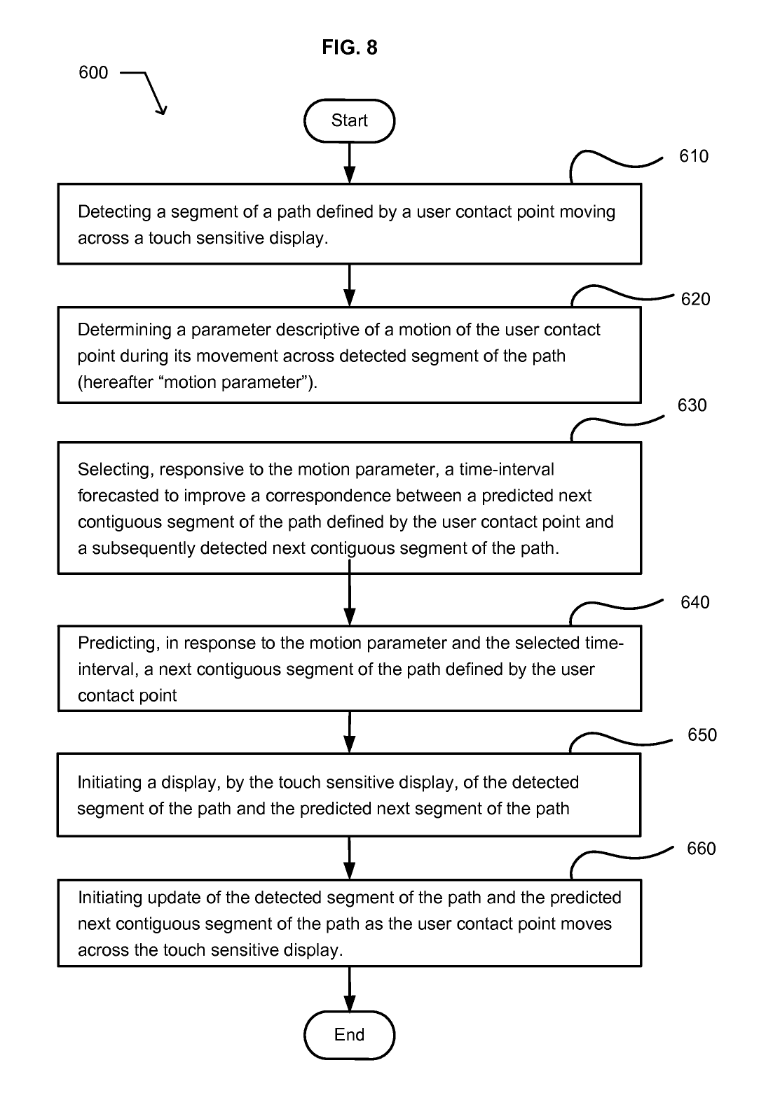

FIG. 8 illustrates an example operational flow 600 implemented in a computing device. After a start operation, the operational flow includes a tracking operation 610. The tracking operation includes detecting a segment of a path defined by a user contact point moving across a touch sensitive display. In an embodiment, the tracking operation may be implemented using the touch tracking circuit 522 described in conjunction with FIG. 7. An analysis operation 620 includes determining a parameter descriptive of a motion of the user contact point during its movement across detected segment of the path (hereafter “motion parameter”). In an embodiment, the analysis operation may be implemented using the motion analysis circuit 524 described in conjunction with FIG. 7. An interval selection operation 630 includes selecting responsive to the motion parameter a time-interval forecasted to improve a correspondence between a predicted next contiguous segment of the path defined by the user contact point and a subsequently detected next contiguous segment of the path. In an embodiment, the interval selection operation may be implemented using the interval selection circuit 526 described in conjunction with FIG. 7. A prediction operation 640 includes predicting in response to the motion parameter and the selected time-interval a next contiguous segment of the path defined by the user contact point. In an embodiment, the prediction operation may be implemented using the predictive filter 528 described in conjunction with FIG. 7. A display operation 650 includes initiating a display by the touch sensitive display of the detected segment of the path and the predicted next segment of the path. In an embodiment, the display operation may be implemented by the latency compensation circuit 532 initiating the displaying by the touch sensitive display 210 described in conjunction with FIG. 7. An update operation 660 includes initiating an update of the detected segment of the path, and the predicted next contiguous segment of the path as the user contact point moves across the touch sensitive display. In an embodiment, the update operation may be implemented using the updating circuit 534 described in conjunction with FIG. 7. The operational flow includes an end operation.

In an embodiment, the selecting of the interval selection operation 630 includes selecting an updated time-interval in response to a change in an aspect of the motion parameter. In an embodiment, the selecting includes selecting an updated time-interval in response to each instance of an updating of the detected segment of the path. In an embodiment, the selecting includes selecting an updated time-interval based on a schedule. In an embodiment, the interval selection circuit is configured to update the time-interval in response to a change of a user of the apparatus. In an embodiment, the initiating of the display operation 650 further includes initiating an update of the selected time-interval setting, the detected segment of the path, and the predicted next contiguous segment of the path as the user contact point moves across the touch sensitive display.

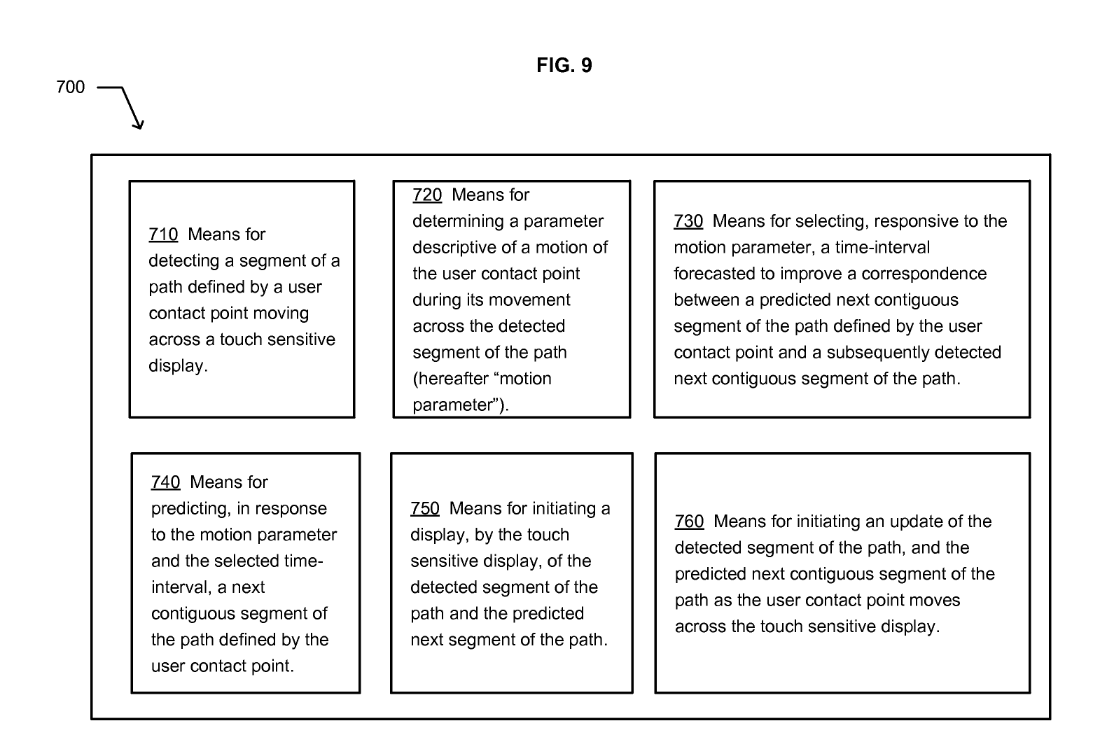

FIG. 9 illustrates an example apparatus 700. The apparatus includes means 710 for detecting a segment of a path defined by a user contact point moving across a touch sensitive display. The apparatus includes means 720 for determining a parameter descriptive of a motion of the user contact point during its movement across the detected segment of the path (hereafter “motion parameter”). The apparatus includes means 730 for selecting responsive to the motion parameter a time-interval forecasted to improve a correspondence between a predicted next contiguous segment of the path defined by the user contact point and a subsequently detected next contiguous segment of the path. The apparatus includes means 740 for predicting in response to the motion parameter and the selected time-interval a next contiguous segment of the path defined by the user contact point. The apparatus includes means 750 for initiating a display by the touch sensitive display of the detected segment of the path and the predicted next segment of the path. The apparatus includes means 760 for initiating an update of the detected segment of the path, and the predicted next contiguous segment of the path as the user contact point moves across the touch sensitive display.

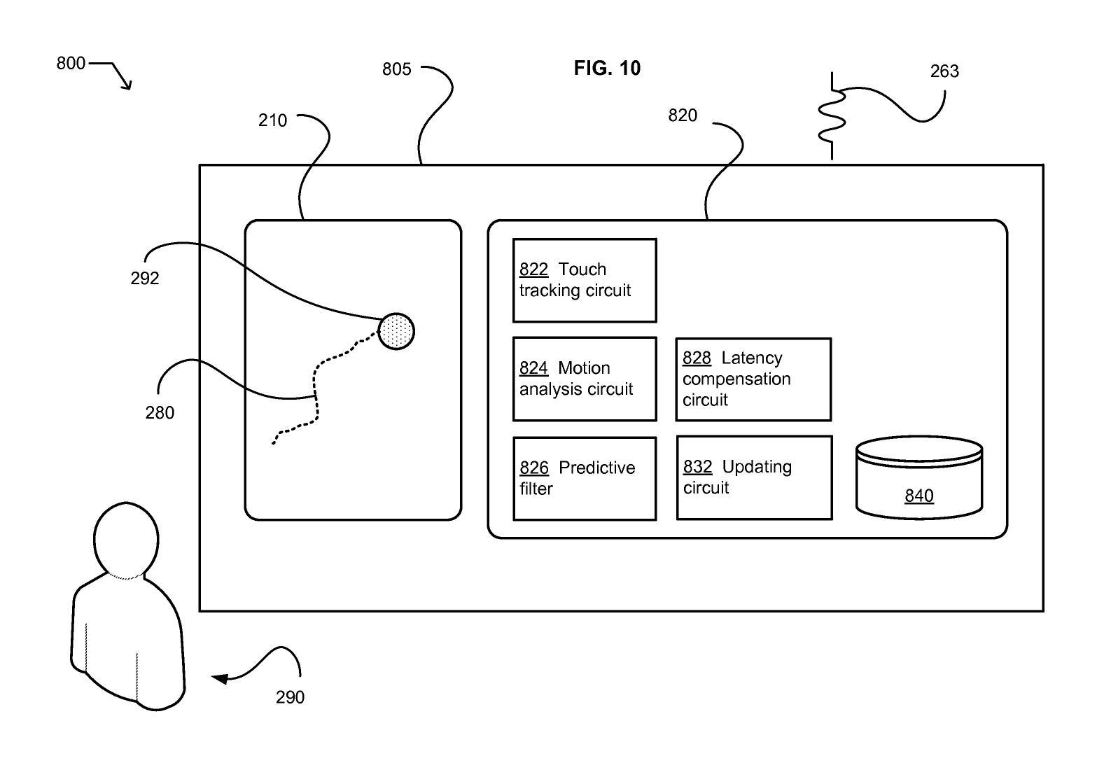

FIG. 10 schematically illustrates an example environment 800 in which embodiments may be implemented. The environment includes a device 805, illustrated as a computing device, and the user 290. In an embodiment, the device may include the thin computing device 20 illustrated in the computing environment 19 described in conjunction with FIG. 1. In an embodiment, the device may include the general purpose computing device 110 described in conjunction with the general purpose computing environment 100. The device includes the touch sensitive display 210 and an apparatus 820.

The apparatus 820 includes a touch tracking circuit 822 configured to detect a segment of the path 280 defined by the user contact point 292 moving across the touch sensitive display 210. A motion analysis circuit 824 is configured to determine (i) a parameter descriptive of a motion of the user contact point during its movement across the detected segment of the path (hereafter “motion parameter”), and an indicator of an impending change in the motion of the user contact point occurring during its movement across the detected segment of the path (hereafter “indicator parameter”). A predictive filter 826 is configured to predict in response to the motion parameter and the indicator parameter a next contiguous segment of the path defined by the user contact point. A latency compensation circuit 828 is configured to initiate a display by the touch sensitive display 210 of the detected segment of the path and the predicted next segment of the path. An updating circuit 832 is configured to update the detected segment of the path, the motion parameter, the indicator parameter, and the predicted next contiguous segment of the path as the user contact point moves across the touch sensitive display. In an embodiment, the apparatus includes a computer readable storage media 840.

In an embodiment, the touch tracking circuit 822 is configured to detect a segment of a path 280 described or formed by the user contact point 292 moving across the touch sensitive display 210. In an embodiment, the indicator of an impending change includes a change in a tilt of a finger or of a handheld stylus forming the user contact point. For example, the change in tilt may be relative to the touch sensitive display. For example, the change in tilt may be relative to the earth's horizon. In an embodiment, the indicator of an impending change includes a flexing of a finger forming the user contact point, or of a flexing of one or more fingers holding a handheld stylus forming the user contact point. In an embodiment, the indicator of an impending change includes a twisting of a finger forming the user contact point, or of a twisting of a handheld stylus forming the user contact point relative to the touch sensitive display. In an embodiment, the indicator of an impending change includes a change in a user's hand grip on a handheld stylus forming the user contact point. For example, the change may include a change in position of a user's hand grip. In an embodiment, the indicator of an impending change includes a change in a force applied by the user to the touch sensitive display at the contact point.

In an embodiment, the predictive filter 826 is further configured to adjust a technique of the predictive filter in response to the indicator parameter. In an embodiment, the predictive filter is further configured to adjust or change a parameter of a motion prediction system of the predictive filter in response to the indicator parameter. In an embodiment, the adjust or change of a parameter of a motion prediction system includes shortening a sampling interval, or decreasing a prediction model's inertia. In an embodiment, the adjust or change of a parameter of a motion prediction system includes changing a weight given the motion parameter. In an embodiment, the adjust or change of a parameter of a motion prediction system includes adjusting or changing a type or value of a parameter employed by a motion prediction system. In an embodiment, the adjust or change of a parameter of a motion prediction system includes adjusting or changing a weighting of one type of motion compared to another by the motion prediction system.

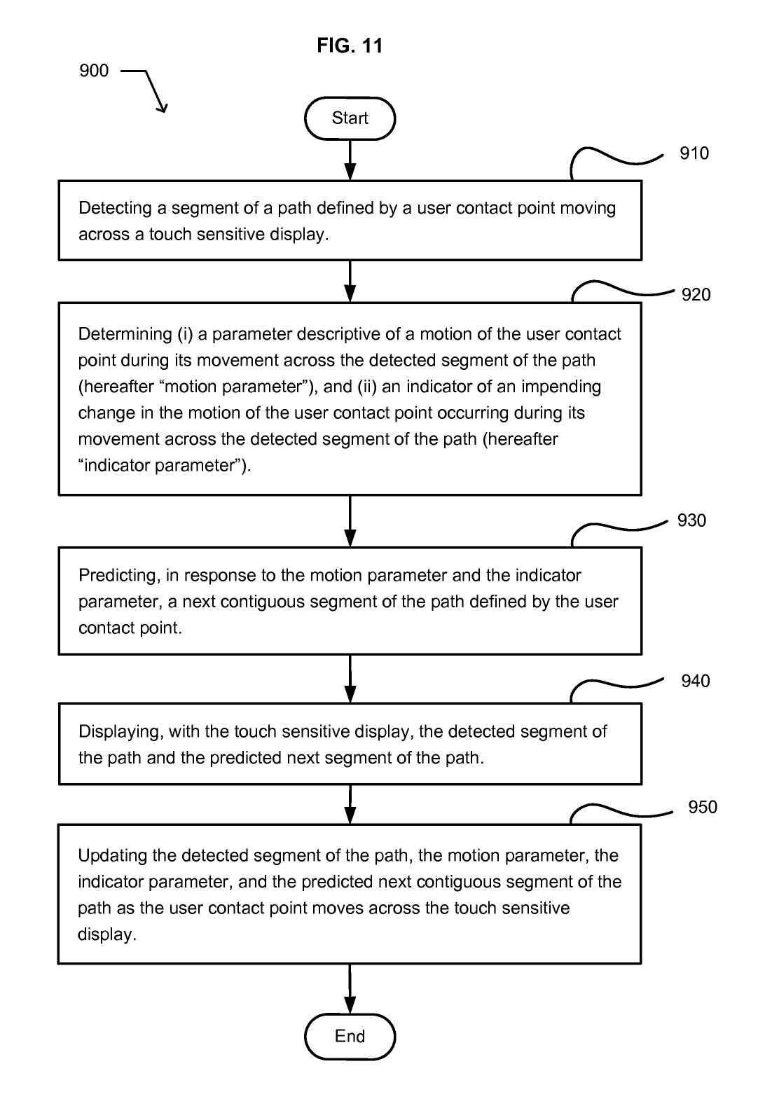

FIG. 11 illustrates an example operational flow 900 implemented in a computing device. In an embodiment, the computing device may include the thin computing device 20 illustrated in the computing environment 19 described in conjunction with FIG. 1. In an embodiment, the device may include the general purpose computing device 110 described in conjunction with the general purpose computing environment 100 described in conjunction with FIG. 2. After a start operation, the operational flow includes a tracking operation 910. The tracking operation includes detecting a segment of a path defined by a user contact point moving across a touch sensitive display. In an embodiment, the tracking operation may be implemented using the touch tracking circuit 822 described in conjunction with FIG. 10. An analysis operation 920 includes determining a parameter descriptive of a motion of the user contact point during its movement across the detected segment of the path (hereafter “motion parameter”). The analysis operation includes determining an indicator of an impending change in the motion of the user contact point occurring during its movement across the detected segment of the path (hereafter “indicator parameter”). In an embodiment, the analysis operation may be implemented using the motion analysis circuit 824 described in conjunction with FIG. 10. A prediction operation 930 includes predicting in response to the motion parameter and the indicator parameter a next contiguous segment of the path defined by the user contact point. In an embodiment, the prediction operation may be implemented using the predictive filter 826 described in conjunction with FIG. 10. A display operation 940 includes displaying with the touch sensitive display the detected segment of the path and the predicted next segment of the path. In an embodiment, the display operation may be implemented by the latency compensation circuit 828 initiating a display by the touch sensitive display 210 as described in conjunction with FIG. 10. An update operation 950 includes updating the detected segment of the path, the motion parameter, the indicator parameter, and the predicted next contiguous segment of the path as the user contact point moves across the touch sensitive display. In an embodiment, the update operation may be implemented using the updating circuit 832 described in conjunction with FIG. 10. The operational flow includes an end operation.

In an embodiment, the predicting of the prediction operation 930 further includes adjusting a prediction technique in response to the indicator parameter. In an embodiment, the predicting further includes adjusting or changing a parameter of a motion prediction technique of the predictive filter in response to the indicator parameter.

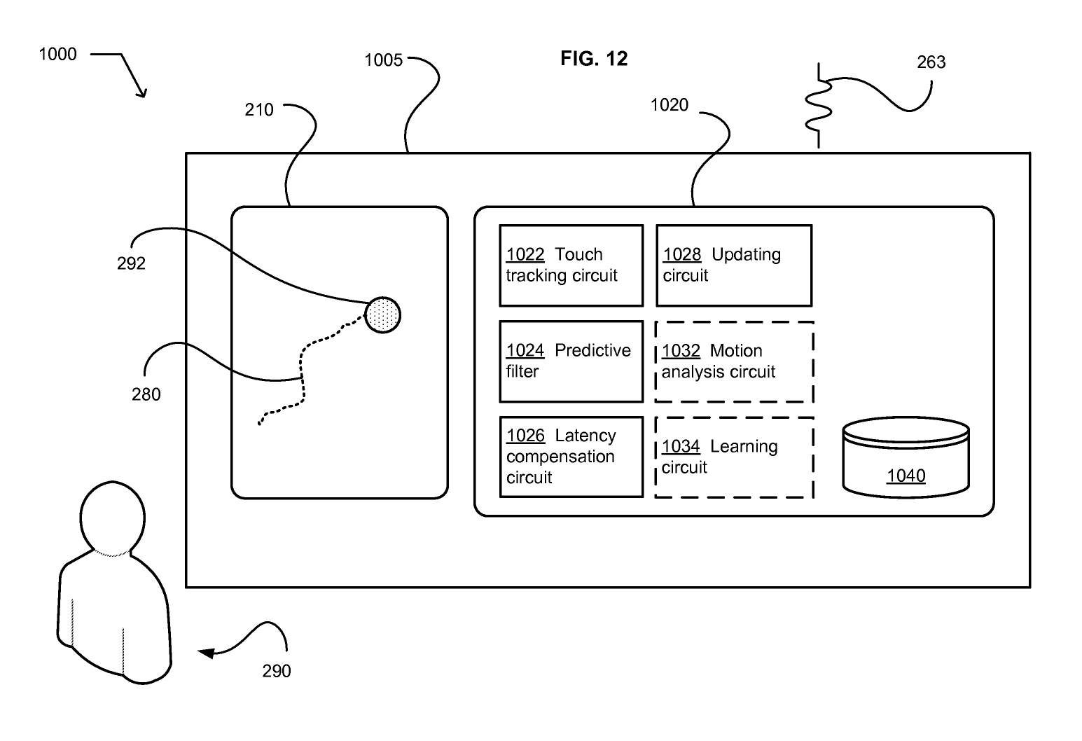

FIG. 12 schematically illustrates an example environment 1000 in which embodiments may be implemented. The environment includes a device 1005, illustrated as a computing device, and the user 290. In an embodiment, the device may include the thin computing device 20 illustrated in the computing environment 19 described in conjunction with FIG. 1. In an embodiment, the device may include the general purpose computing device 110 described in conjunction with the general purpose computing environment 100. The device includes the touch sensitive display 210 and an apparatus 1020.

The apparatus 1020 includes a touch tracking circuit 1022 configured to detect a segment of the path 280 defined by the user contact point 292 moving across the touch sensitive display 210. The apparatus includes a predictive filter 1024 configured to predict a next contiguous segment of the path defined by the user contact point in response to an adaptively learned motion parameter. The adaptively learned motion parameter is based on at least two previous instances of the determined motion parameters respectively descriptive of a motion of a user contact point during its movement across the touch sensitive display. The apparatus includes a latency compensation circuit 1026 configured to initiate a display by the touch sensitive display of the detected segment of the path and the predicted next contiguous segment of the path. The apparatus includes an updating circuit 1028 configured to update the detected segment of the path and the predicted next contiguous segment of the path as the user contact point moves across the touch sensitive display.

In an embodiment, the adaptively learned motion parameter includes an adaptively learned motion parameter associated with a specific human user. In an embodiment, the adaptively learned motion parameter includes an adaptively learned motion parameter associated with a specific human user and based upon a history of at least two motion parameters determined in response to the path 280 defined by the user contact point 290 moving across the touch sensitive display 210 and formed by the specific human user. In an embodiment the adaptively learned motion parameter associated with a specific human user comprises a motion parameter learned during a previous usage session involving the user, and can be retrieved from a computer readable storage media 1040 having stored thereupon the previously learned motion parameter. In some embodiments the previously learned motion parameters were learned during a previous usage session involving device 1005, while in other embodiments the previously learned motion parameters were learned during a previous usage session involving a different device. In an embodiment, the user contact point is formed by the specific human user. In an embodiment, the adaptively learned motion parameter includes an adaptively learned motion parameter associated with a specific software application running on the apparatus 1005. In an embodiment, the adaptively learned motion parameter includes an adaptively learned motion parameter associated with a specific software application running on the apparatus, and based upon a history of at least two motion parameters determined in response to a path defined by the user contact point moving across a touch sensitive display in conjunction with a user interaction with the specific software application.

In an embodiment, the predictive filter 1024 is configured to predict a next contiguous segment of the path 280 defined by the user contact point 292 in response to a learned motion parameter associated with a specific user and in response to a learned motion parameter associated with a specific software application running on the apparatus 1005. In an embodiment, the apparatus further includes a motion analysis circuit 1032 configured to determine a parameter descriptive of a motion of the user contact point during its current movement across detected segment of the path (hereafter “current motion parameter”). In an embodiment, the predictive filter is further configured to predict a next contiguous segment of the path defined by the user contact point in response to the learned motion parameter and the current motion parameter. In an embodiment, the apparatus includes a learning circuit 1034 configured to adaptively learn the motion parameter. In an embodiment, the apparatus includes a computer readable storage media 1040 having stored thereupon the adaptively learned motion parameter. In an embodiment, the computer readable storage media includes a non-transitory computer readable storage media. In an embodiment, the apparatus includes a communication circuit configured to transmit the adaptively learned motion parameter to a remote device. In an embodiment, the apparatus includes a communication circuit configured to receive the adaptively learned motion parameter from a remote device.

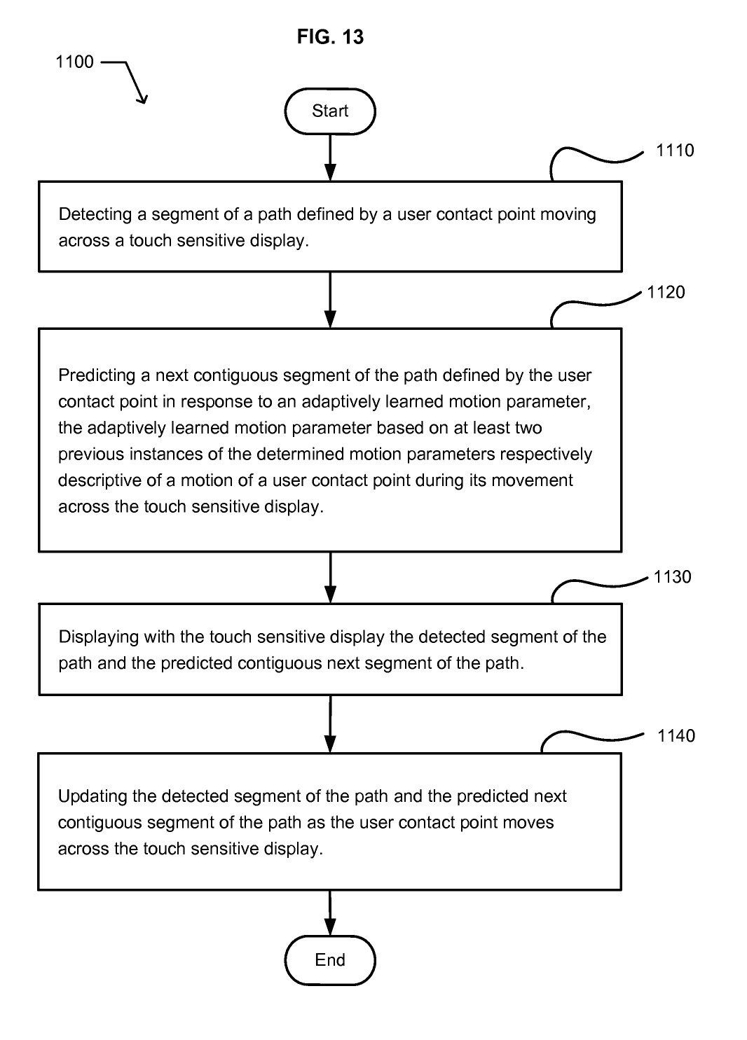

FIG. 13 illustrates an example operational flow 1100 implemented in a computing device. In an embodiment, the computing device may include the thin computing device 20 illustrated in the computing environment 19 described in conjunction with FIG. 1. In an embodiment, the computing device may include the general purpose computing device 110 described in conjunction with the general purpose computing environment 100 described in conjunction with FIG. 2. After a start operation, the operational flow includes a tracking operation 1110. The tracking operation includes detecting a segment of a path defined by a user contact point moving across a touch sensitive display. In an embodiment, the tracking operation may be implemented using the touch tracking circuit 1022 described in conjunction with FIG. 12. A prediction operation 1120 includes predicting a next contiguous segment of the path defined by the user contact point in response to an adaptively learned motion parameter. The adaptively learned motion parameter is based on at least two previous instances of the determined motion parameters respectively descriptive of a motion of a user contact point during its movement across the touch sensitive display. In an embodiment, the prediction operation may be implemented using the predictive filter 1024 described in conjunction with FIG. 12. A display operation 1130 includes displaying with the touch sensitive display the detected segment of the path and the predicted next contiguous segment of the path. In an embodiment, the display operation may be implemented by the latency compensation circuit 1026 initiating the displaying by the touch sensitive display 210 as described in conjunction with FIG. 12. An update operation 1140 includes updating the detected segment of the path and the predicted next contiguous segment of the path as the user contact point moves across the touch sensitive display. In an embodiment, the update operation may be implemented using the updating circuit 1028 described in conjunction with FIG. 12. The operational flow includes an end operation.

In an embodiment, the operational flow 1100 includes adaptively learning the motion parameter.

In an embodiment, the operational flow includes determining a parameter descriptive of a motion of the user contact point during its current movement across detected segment of the path (hereafter “current motion parameter”). In an embodiment, the prediction operation 1120 further includes predicting a next contiguous segment of the path defined by the user contact point in response to the adaptively learned motion parameter and the current motion parameter.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus comprising:
a touch tracking circuit configured to detect a segment of a path defined by a user contact point moving across a touch sensitive display;
a motion analysis circuit configured to determine a parameter descriptive of a motion of the user contact point during its movement across the detected segment of the path (hereafter “motion parameter”);
a predictive filter configured to predict in response to the motion parameter a next contiguous segment of the path defined by the user-contact point moving across the touch sensitive display;
a latency compensation circuit configured to initiate a display by the touch sensitive display of the detected segment of the path and the predicted next segment of the path; and
an updating circuit configured to initiate an update of the detected segment of the path and the predicted next contiguous segment of the path as the user contact point moves across the touch sensitive display.

2. The apparatus of claim 1, wherein the user contact point includes a tip of a finger of the user.

3. The apparatus of claim 1, wherein the user contact point includes a tip of a handheld stylus held by the user.

4. The apparatus of claim 1, wherein the path is defined by the user contact point moving across and touching the touch sensitive display.

5. The apparatus of claim 1, wherein the motion analysis circuit is further configured to analyze an aspect of the movement of the user contact point across the detected segment of the path, and to determine a parameter descriptive of a motion of the user contact point during its movement across a detected segment of the path based on the analyzed aspect.

6. The apparatus of claim 1, wherein the motion parameter is descriptive of an aspect of the motion of the user contact point.

7. The apparatus of claim 1, wherein the motion parameter is descriptive of the motion of the user contact point during a portion of its movement across detected segment of the path.

8. The apparatus of claim 1, wherein the motion parameter includes a velocity parameter of the user contact point.

9. (canceled)

10. The apparatus of claim 1, wherein the motion parameter includes an acceleration parameter of the user contact point.

11. (canceled)

12. The apparatus of claim 1, wherein the motion parameter includes an orientation or motion of the user contact point relative to the touch sensitive display.

13. The apparatus of claim 1, wherein the motion parameter includes a difference between a detected motion and a previously made prediction of the motion.

14. (canceled)

15. The apparatus of claim 1, wherein the motion parameter includes (i) a motion parameter of the user contact point and (ii) a motion parameter of a finger or a hand of the user forming the contact point, or of a handheld stylus forming the contact point.

16. The apparatus of claim 1, wherein the motion analysis circuit is further configured to determine a parameter descriptive of a motion of the user contact point defined by a tip of a handheld stylus during its movement across the detected segment of the path, the determination responsive to a signal generated by the handheld stylus and indicative of a sensed parameter descriptive of a motion of the handheld stylus during its movement across detected segment of the path.

17. The apparatus of claim 16, wherein the signal includes data indicative of a velocity or acceleration of the handheld stylus.

18.-19. (canceled)

20. The method of claim 16, wherein the sensed parameter includes a sensed parameter indicative of an orientation or motion of the handheld stylus relative to the touch sensitive display.

21. The method of claim 16, wherein the sensed parameter includes a sensed parameter indicative of a motion of the tip of the handheld stylus and a sensed parameter of a motion of another portion of the handheld stylus.

22. The apparatus of claim 16, wherein the motion analysis circuit is further configured to determine a parameter descriptive of a motion of the tip of the handheld stylus during its movement across the detected segment of the path, the determination responsive to (i) a signal generated by the handheld stylus and indicative of a sensed parameter descriptive of a motion of the tip of the handheld stylus during its movement across the detected segment of the path, and (ii) an aspect of the movement of the tip of the handheld stylus across the detected segment of the path.

23. The apparatus of claim 1, wherein the predictive filter is configured to predict in response to the detected motion parameter a next contiguous segment of the path of the user contact point likely to occur during a time interval.

24. The apparatus of claim 23, wherein the time interval is a function of the latency period of the apparatus.

25.-26. (canceled)

27. The apparatus of claim 23, wherein the predictive filter is further configured to determine the time interval based upon a weighted error rate.

28. The apparatus of claim 1, wherein the predictive filter is further configured to determine an optimum update schedule usable by the updating circuit in response to a historical iterative convergence between the predicted likely next segment and the actual detected next segment.

29. The apparatus of claim 1, wherein the predictive filter is further configured to dynamically determine an optimized update schedule usable by the updating circuit.

30. The apparatus of claim 1, wherein the predictive filter is configured to predict in response to the motion parameter of the user contact point and in response to a motion parameter of the touch sensitive display a next contiguous segment of the path of the user contact point moving across the touch sensitive display.

31.-32. (canceled)

33. The apparatus of claim 1, wherein the updating circuit is configured to manage a dynamic updating of the detected segment of the path and the predicted next contiguous segment of the path as the user contact point moves across the touch sensitive display.

34. The apparatus of claim 1, wherein the updating circuit is configured to initiate an update of the detected segment of the path and the predicted next contiguous segment of the path as the user contact point moves across the touch sensitive display based on a schedule.

35.-36. (canceled)

37. The apparatus of claim 1, wherein the updating circuit is configured to initiate an update of the detected segment of the path and the predicted next contiguous segment of the path as the user contact point moves across the touch sensitive display based on a length of the detected segment of the path.

38. The apparatus of claim 1, wherein the updating circuit is further configured to initiate updates while a handheld stylus moves across the touch sensitive display.

39. The apparatus of claim 1, wherein the updating circuit is configured to initiate a display by the touch sensitive display of the detected segment of the path and the predicted next segment of the path concurrent with the movement across the touch sensitive display by the user contact point.

40. (canceled)

41. The apparatus of claim 1, wherein the apparatus further comprises:
the touch sensitive display.

42. The apparatus of claim 1, wherein the apparatus further comprises:
a computing device that includes the touch sensitive display.

43. The apparatus of claim 1, wherein the apparatus further comprises:
a receiver circuit configured to receive a signal generated by a handheld stylus.

44. The apparatus of claim 1, further comprising:
a learning circuit configured to adaptively learn a motion parameter associated with a specific user based upon a history of at least two motion parameters determined in response to the path defined by a user contact point moving across the touch sensitive display.

45. (canceled)

46. The apparatus of claim 1, further comprising:
a learning circuit configured to adaptively learn a motion parameter associated with a specific software application running on the apparatus and based upon a history of at least two motion parameters determined in response to a path defined by the user contact point moving across the touch sensitive display.

47. (canceled)

48. The apparatus of claim 1, further comprising:
a non-transitory computer readable storage media.

49. A method implemented in a computing environment and comprising:
detecting a segment of a path defined by a user contact point moving across a touch sensitive display;
determining a parameter descriptive of a motion of the user contact point during its movement across the detected segment of the path (hereafter “motion parameter”);
predicting in response to the motion parameter a next contiguous segment of the path of the user contact point moving across the touch sensitive display;
displaying a human-perceivable rendering of the detected segment of the path and the predicted next segment of the path; and
updating the detected segment of the path and the predicted next contiguous segment of the path as the user contact point moves across the touch sensitive display.

50. The method of claim 49, wherein the determining includes analyzing an aspect of the movement of the user contact point across the detected segment of the path, and determining a parameter descriptive of a motion of the user contact point during its movement across the detected segment of the path based on the analyzed aspect.

51. The method of claim 49, wherein the determining includes determining a parameter descriptive of a motion of the user contact point during its movement across the detected segment of the path based on a signal generated by the handheld stylus and indicative of a sensed parameter descriptive of a motion of the user contact point during its movement across the detected segment of the path.

52. A method implemented in a computing environment and comprising:
detecting a first segment of a path defined by a user contact point moving across a touch sensitive display of the computing device;
determining a first parameter descriptive of a first motion of the user contact point during its movement across the detected first segment of the path (hereafter “first motion parameter”);
predicting in response to the first motion parameter a second contiguous segment of the path of the user contact point moving across the touch sensitive display;
displaying on the touch sensitive display the detected first segment of the path and the predicted second segment of the path;
detecting a second segment of the path defined by the user contact point moving across the touch sensitive display of the computing device;
determining a second parameter descriptive of a second motion of the user contact point during its movement across the detected second segment of the path (hereafter “second motion parameter”);
predicting in response to the second motion parameter a third contiguous segment of the path defined by the user contact point moving across the touch sensitive display; and
displaying on the touch sensitive display the detected first segment, the detected second segment, and the predicted third segment of the path.

53. The method of claim 52, wherein the detecting a first segment includes detecting a first segment of a continuing path of the user contact point moving across the touch sensitive display.

54. The method of claim 52, wherein the determining a first parameter includes analyzing an aspect of the movement of the user contact point across the detected first segment of the path, and determining a first parameter descriptive of a motion of the user contact point during its movement across detected first segment of the path based on the analyzed aspect.

55. The method of claim 52, wherein the determining a first parameter includes determining a first parameter descriptive of a motion of a tip of a stylus held by the user during its movement across the detected first segment of the path based on a first signal generated by the handheld stylus and indicative of a parameter descriptive of a sensed motion of the tip of the handheld stylus during its movement across the detected first segment of the path.

56.-61. (canceled)

62. The method of claim 52, wherein the first segment and the second segment are contiguous portions of the path of the user contact point.

63. The method of claim 52, wherein the predicted second segment has a time interval at least equal to a detection latency period of the touch sensitive display.

64. (canceled)

65. The method of claim 52, wherein the predicted second segment has an optimized time interval selected in response to an analysis of a movement of the handheld stylus across the touch sensitive display.

66. (canceled)

67. The method of claim 52, wherein the predicted second segment includes a segment of the path of the user contact point moving across the touch sensitive display formed subsequent to the formation of the first segment and not yet detected.

68.-69. (canceled)
